(19) United States
(12) Patent Application Publication
(10) Pub. No.: US 2003/0068921 A1
(43) Pub. Date: Apr. 10, 2003

(54) Computer transmission cable

(75) Inventors: Kuo-Jung Hung, Taipei City (TW); Hsuan-Pai Chen, Yung Ho City (TW)

Correspondence Address: BACON & THOMAS, PLLC, 625 SLATERS LANE, FOURTH FLOOR, ALEXANDRIA, VA, 22314

(73) Assignee: Hsua-Pak CHEN, Taipei Hsien (TW)

(21) Appl. No.: 10/216,791

(22) Filed: Aug. 13, 2002

(30) Foreign Application Priority Data
Oct. 8, 2001 (TW) 090217125

(51) Int. Cl. H01R 11/00

(52) U.S. Cl. 439/502

(57) ABSTRACT

A computer transmission cable having a transmission element which includes multiple lines each having an insulation layer surrounding an outer periphery thereof, a circular enclosure enclosing the lines therein, two connectors respectively connected to two distal ends of the transmission element and engaged with the circular enclosure and a resilient element is received inside the circular enclosure so as to allow the transmission element to be bent and maintained into any shape.

### BACKGROUND OF THE INVENTION

1. Field of the Invention

The present invention relates to a computer transmission cable, and more particularly to a computer transmission cable having therein a resilient element so that the transmission cable is able to be bent to any shape and maintains in that shape for further use.

2. Description of Related Art

As modern technology advances, people become more and more rely on computers. Hence, different computer peripheries are introduced to the market every now and then. Computer users are thus able to install and assemble specific peripheries as required. Accordingly, computer transmission cables are becoming more and more important.

A conventional computer transmission cable is composed of multiple transmission lines, two connectors respectively connected to two distal ends of the multiple transmission lines and an enclosure to encase the multiple transmission lines. Thus, the user is able to use the two connectors to connect to the computer main frame and the chosen peripheries to establish a communication between the computer main frame and the peripheries.

After the assembly of the computer and the completion of establishing communication between the computer main frame and the peripheries, the computer user usually place the computer main frame at the corner of a room or the compartment in a computer desk so that the user is able to hide the cables and maintain environment tidy. However, this leads to a consequence that whenever the user wants to assemble additional computer peripheries, the user will have to move the computer main frame out of the corner or the compartment so as to find out the correct socket(s) to complete the communication between the main frame and the additional peripheries. Especially, when the cables are scattered and tangled, the user will have to sort out the cables first, which increases the difficulty of assembly.

To overcome the shortcomings, the present invention intends to provide an improved computer transmission cable to mitigate or obviate the aforementioned problems.

### SUMMARY OF THE INVENTION

The primary objective of the invention is to provide an improved computer transmission cable which has a resilient element received therein so that the computer transmission cable is able to be bent into any kind of shape and maintained in that shape for further use.

Another objective of the invention is to provide an improved computer transmission cable which is able to increase its structural integrity.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the computer transmission cable of the present invention;

FIG. 2 is a cross sectional view of the computer transmission cable in FIG. 1;

FIG. 3 is a schematic view showing the bending of the cable in FIG. 1;

FIG. 4 is a schematic view showing the application of the cable in FIG. 1; and

FIG. 5 is a perspective view of another embodiment of the cable of the present invention.

### DETAILED DESCRIPTION OF PREFERRED EMBODIMENT

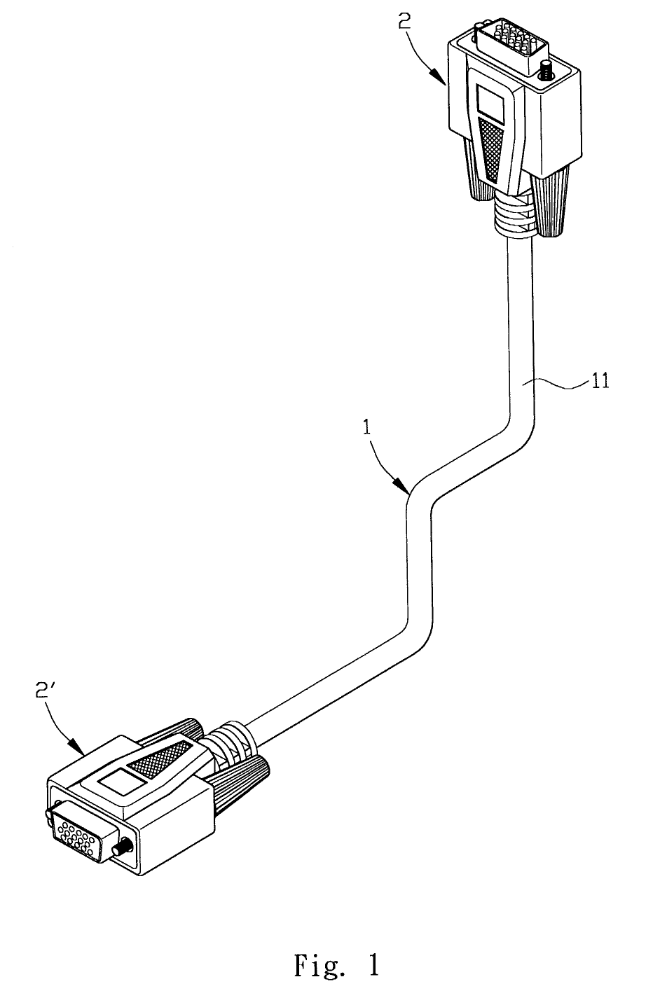

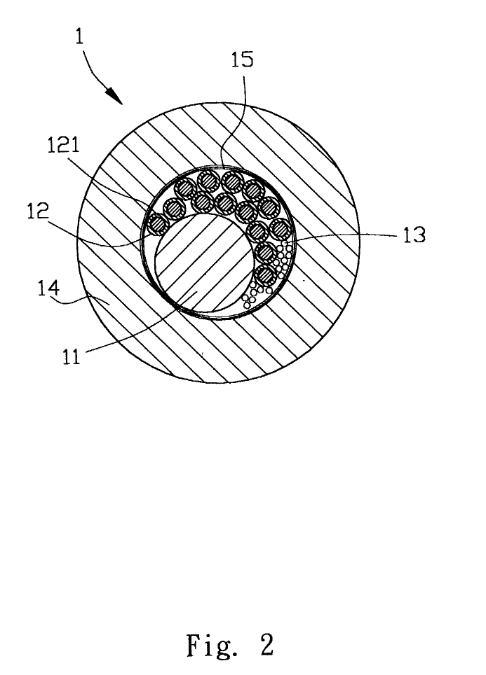

With reference to FIGS. 1 and 2, the computer transmission cable in accordance with the present invention includes a transmission element 1 and two connectors 2, 2′ respectively connected to two different distal ends of the transmission element 1.

The transmission element 1 includes multiple lines 12 each having an insulation layer 121, a circular enclosure 14, multiple filaments 13 which is able to prevent magnetic wave and to increase transmission speed and a resilient element 11.

The lines 12, the filaments 13 and the resilient element 11 are enclosed inside the enclosure 14. The resilient element 11 is made of a metallic material which is able to be bent and maintained in any shape as required. The resilient element 11 is located outside the insulation layer 121. A baffle layer 15 made of an insulation material is sandwiched between the enclosure 14 and the resilient element 11, the lines 12 and the filaments 13. The total length of the transmission element 1 is shorter than 60 cm.

The two connectors 2,2′ are connected to two distal ends of the transmission element 1 by only engaging with the enclosure 14. That is, the resilient element 11 has a length shorter than a length of the enclosure 14 so that the connectors 2,2′ have a larger room to be manipulated. In a preferred embodiment of the present invention, the connectors 2,2′ may be a data bus.

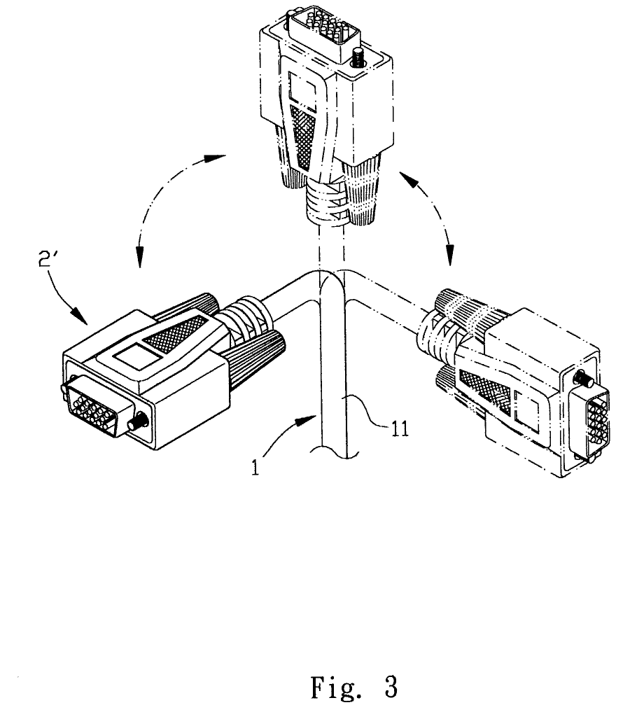

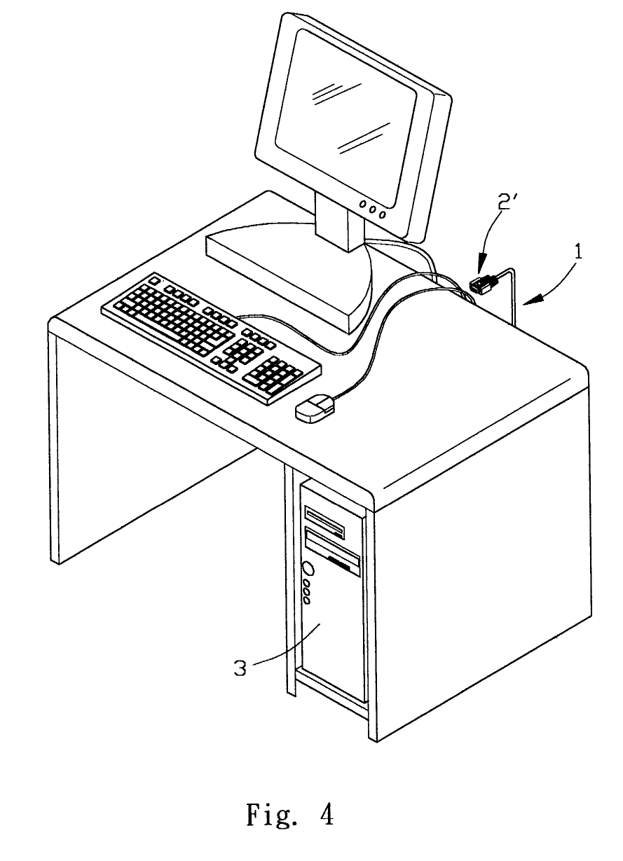

With reference to FIGS. 3 and 4, when the transmission cable of the present invention is in application, the user is able to connect one end of the transmission element 1 to a socket (not shown) in the back side of a computer main frame 3. Then, the user is able to bent the transmission cable so as to allow the other end of the transmission element 1 to be supported by the resilient element 11 in the air. Therefore, whenever the user is going to add an additional computer periphery, the user is able to readily locate the connector 2 or 2′ hanging in the air. Furthermore, when the user is disassembling the transmission cable, the structural integrity of the transmission cable is reinforced due to the resilient element 11.

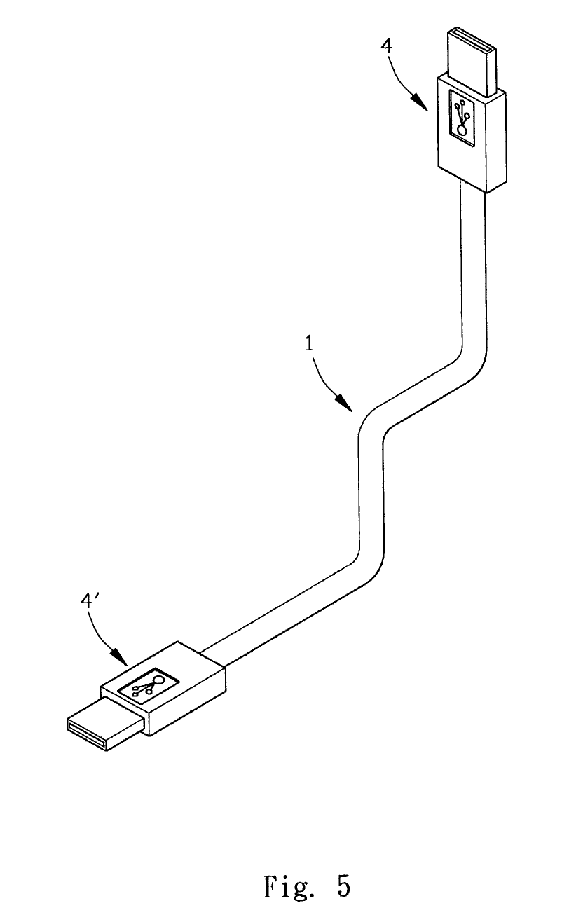

With reference to FIG. 5, it is noted that the connectors 4,4′ may be a USB (universal series bus) so as to increase the application of the invention.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A computer transmission cable having a transmission element which includes multiple lines each having an insulation layer surrounding an outer periphery thereof, a circular enclosure enclosing the lines therein and two connectors respectively connected to two distal ends of the transmission element and engaged with the circular enclosure, wherein the improvements comprise:
a resilient element is received inside the circular enclosure so as to allow the transmission element to be bent and maintained into any shape.

2. The computer transmission cable as claimed in claim 1, wherein the resilient has a length shorter than a length of the enclosure.

3. The computer transmission cable as claimed in claim 1, wherein the connector is a data bus.

4. The computer transmission cable as claimed in claim 1, wherein the connector is a USB.

5. The computer transmission cable as claimed in claim 1, wherein the transmission element has a length less than 60cm.
